(19) United States
(12) Patent Application Publication
(10) Pub. No.: US 2007/0076632 A1
(43) Pub. Date: Apr. 5, 2007

(54) Network port for tracing a connection topology

(75) Inventor: Paymon Ghamami, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/242,869

(22) Filed: Oct. 5, 2005

(51) Int. Cl. H04L 12/28; H04J 3/14; H04J 1/16

(52) U.S. Cl. 370/254; 370/242

(57) ABSTRACT

A network port and method for tracing a connection topology between at least two connected devices are described. The network port includes a logic circuit connected with a communication path for connecting with another network port. The logic circuit is arranged to generate and transmit a trace signal responsive to receipt of an activation signal. The logic circuit is arranged to generate an indicator indicative of at least one of: receipt of a reply signal responsive to transmission of the trace signal and expiration of a predetermined time period. The method includes transmitting a trace signal from a first device to a second device responsive to receipt of an activation signal and generating an indicator indicative of at least one of: receipt of a reply signal from the second device responsive to transmission of the trace signal and expiration of a predetermined time period.

### FIELD

The disclosed embodiments relate to a network port for tracing a connection topology and a corresponding method thereof.

### BACKGROUND

It is known in the art to manually, visually trace cable connections between devices. A user visually follows a cable from one connecting plug end to the other connecting plug end to determine which devices the cable connects. The difficulty of tracing cable connections ranges from the relatively simple case of two stand-alone devices, e.g., two computers directly connected via a cable or a computer and a network printer to which the computer is directly connected, to the case of a switching center in which racks of networking switches having numerous ports for receiving cable plug ends are interconnected. The difficulty of tracing the cable connections increases as the number of connections and number of connections per area increases.

Additionally, tracing difficulty may increase as the distance between connection ends, i.e., devices, increases. For example, in an office setting to devices may be positioned relatively close to one another; however, the connection between the two devices many pass through one or more interceding and walls and /or cable raceways thereby increasing the tracing difficulty.

### SUMMARY

The present embodiments provide a network port for tracing a connection topology and a method thereof.

A network port embodiment includes a logic circuit connected with a communication path for connecting with another network port. The logic circuit is arranged to generate and transmit a trace signal responsive to receipt of an activation signal. The logic circuit is arranged to generate an indicator indicative of at least one of: receipt of a reply signal responsive to transmission of the trace signal and expiration of a predetermined time period.

Another network port embodiment includes a logic circuit connected with a network cable via a network plug received in the network port and arranged to generate a reply signal in response to receipt of a trace signal from the network plug. The reply signal is a predetermined format packet. The logic circuit is arranged to generate an indicator signal responsive to: receipt of the trace signal and generation of the reply signal. The network port further includes a signal generator connected with the logic circuit and arranged to generate an indicator responsive to an indicator signal from the logic circuit.

A method embodiment includes transmitting a trace signal from a first device to a second device responsive to receipt of an activation signal and generating an indicator indicative of at least one of: receipt of a reply signal from the second device responsive to transmission of the trace signal and expiration of a predetermined time period.

Still other advantages of the disclosed embodiments will become readily apparent to those skilled in the art from the following detailed description, wherein the preferred embodiments are shown and described, simply by way of illustration of the best mode contemplated of carrying out the embodiments. As will be realized, the embodiments are capable of other and different embodiments, and the several details are capable of modifications in various obvious respects, all without departing from the embodiments. The advantages of the disclosed embodiments may also be realized and attained by the means of the instrumentalities and combinations particularly pointed out in the appended claims.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level diagram of an embodiment;

FIG. 2 is a high level block diagram of another version of the FIG. 1 embodiment;

FIG. 3 is a high level block diagram of another version of the FIG. 2 embodiment;

FIG. 4 is a high level block diagram of a process flow of a logic circuit according to an embodiment;

FIG. 5 is a high level block diagram of a portion of the process flow of the FIG. 4 embodiment;

FIG. 6 is a high level block diagram of a network usable in conjunction with an embodiment; and

FIG. 7 is a functional process flow diagram of another version of the FIG. 4 embodiment.

### DETAILED DESCRIPTION

In contrast with the above-described approaches, the mechanism of the present embodiments provides a network port for tracing a connection topology and a method thereof. An activating signal, e.g., a predetermined packet, generated at a first device is received by a second device connected with the first device and responsive to the activating signal. The second device responds to receipt of the activating signal by either: driving a reply signal, e.g., a second predetermined packet, to the first device, generating an audio and/or visual signal at the second device, generating an activating signal to other devices connected to the second device, or a combination thereof. If the second device generates an activating signal to other devices connected thereto, the second device, in at least one embodiment, waits for replies from the other devices prior to generating a reply to the first device. In this manner, the physical topology of one or more connections between the first and second devices may be traced, as well as, the physical topology of one or more connections between first, second, and other connected devices may be traced.

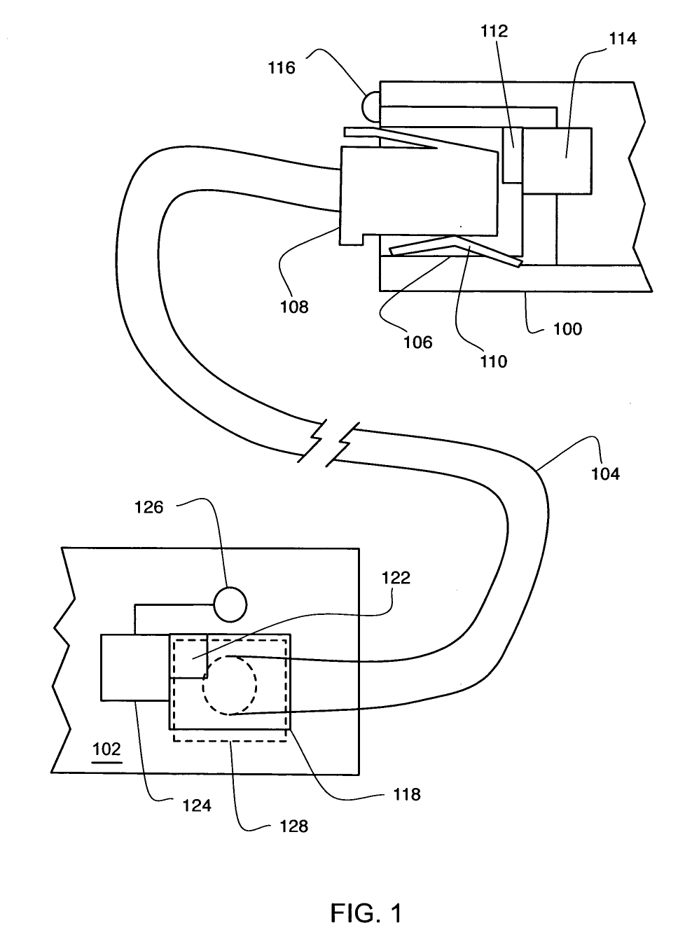

FIG. 1 depicts a high level diagram of an embodiment utilizing two connected devices. A first device 100, e.g., a network switch, connects to a second device 102, e.g., a second network switch, via a cable 104, e.g., a wired network cable connection such as an Ethernet cable, or other wired connection mechanism. First device 100 includes a receiver 106 for receiving a cable plug 108 at an end of cable 104.

Receiver 106 includes one or more contacts 110 for making an electrical connection between wiring in cable 104 and further electronics (not shown) connected with/part of device 100. In operation, a user inserts plug 108 into receiver 106 in order to cause plug 108 to electrically connect with contact 110. As depicted in the FIG. 1 embodiment, receiver 106 includes an actuator switch 112, e.g., a micro-switch, a pressure activated switch, or other switch device, at the rear of the receiver cavity interior.

Switch 112, connected with a logic circuit 114, e.g., a controller, micro-controller, central processing unit, or other processing device, etc., of device 100 transmits a switch activation signal to the logic circuit responsive to activation by plug 108. Logic circuit 114 is also electrically connected to one or more of contacts 110 and an indicator 116, e.g., a light emitting diode. The operation of logic circuit 114 is described more fully below. A user wishing to activate switch 112 pushes plug 108 farther into receiver 106 and into actuating contact with the switch. Withdrawal of plug 108 by the user causes deactivation of switch 112.

Insertion of plug 108 in receiver 106 electrically connects cable 104 with contact 110 without necessarily activating actuator switch 112. Additionally, an electrical connection between receiver 106 and contact 110 is maintained during activation of switch 112 by further insertion of plug 108 into receiver 106.

In other embodiments, switch 112 is located in different positions within or adjacent cavity 106 and different manipulations of plug 108 cause activation of the switch. Additionally, as described below in still other embodiments, switch 112 is mounted external of receiver 106 and is directly manipulable by a user without requiring manipulation of plug 108.

Logic circuit 114 responds to receipt of the switch activation signal from switch 112 by causing generation and transmission of a trace signal over cable 104 via contact 110. The trace signal is a predetermined signal transmitted from first device 100 to second device 102 which causes the second device to respond with a reply signal to the first device. In other embodiments, logic circuit 114 also causes indicator 116 to illuminate responsive to the switch activation signal.

In an embodiment, the trace signal is one or more specially-formed network packets recognizable by second device 102. In another embodiment, the trace signal includes identifying information specific to first device 100, e.g., the ethernet media access control (MAC) address, the internet protocol (IP) address, or other identifying information relevant to the first device.

In an embodiment, the reply signal is one or more specially-formed network packets recognizable by first device 100. Similar to the trace signal, in another embodiment, the reply signal includes identifying information specific to second device 102, e.g., the Ethernet MAC address, the internet protocol (IP) address, or other identifying information relevant to the second device. In this manner, first device 100 receives information concerning the device connected to the other end of cable 104.

FIG. 1 depicts a front view of second device 102 in contrast to the side view of first device 100. As described above with respect to first device 100, second device 102 includes a receiver 118 including contacts (not shown) and an actuator switch 122, a logic circuit 124 connected with the contacts, the actuator switch, and an indicator 126 connected with the logic circuit. Operation of receiver 118 and logic circuit 124 responsive to a user manipulating a plug 128 at another end of cable 104 occurs as described above with respect to first device 100. A user pressing plug 128 into receiver 118 causes activation of actuator switch 122 which, in turn, generates and transmits a switch activation signal to logic circuit 124. Responsive to receipt of the activation signal, logic circuit 124 generates and transmits a trace signal, as described above with respect to first device 100, to the first device via cable 104.

In another embodiment, logic circuit 124 causes indicator 126 to illuminate responsive to the switch activation signal.

As described above, receipt by second device 102 of a trace signal from first device 100 via cable 104 causes logic circuit 124 to generate and transmit a reply signal to the first device over cable 104. In an embodiment, the reply signal includes information identifying second device 102 as described above, e.g., the Ethernet MAC address, the internet protocol (IP) address, or other identifying information relevant to the second device.

In an embodiment, first device 100 receives the reply signal from second device 102 and provides an indication of receipt to the user. For example, upon receipt of the reply signal, logic circuit 114 causes the first device 100 to display the reply signal to a user via a connected display (not shown). In another embodiment, logic circuit 114 causes the generation and transmission of a reporting signal, e.g., a specially formed packet including all or a portion of the trace signal and/or the reply signal, to a third device (not shown) connected with first device 100.

In a further embodiment, receipt by second device 102 of the trace signal causes the second device to illuminate indicator 126 and thereby indicate to which device first device 100 is connected via cable 104. Assuming second device 102 includes more than one receiver 118, e.g., multiple ports in a network switch-type device, and each receiver has a corresponding indicator 126, receipt of the trace signal from first device 100 causes the second device to indicate to which of the receivers cable 104 is connected.

In other embodiments, logic circuit 124 causes indicator 126 to illuminate for a predetermined period of time or in a predetermined pattern. In still other embodiments, logic circuit 124 causes indicator 126 to illuminate until receipt of a second trace signal from first device 100, e.g., initiated by a user once again manipulating plug 108 to actuate switch 112.

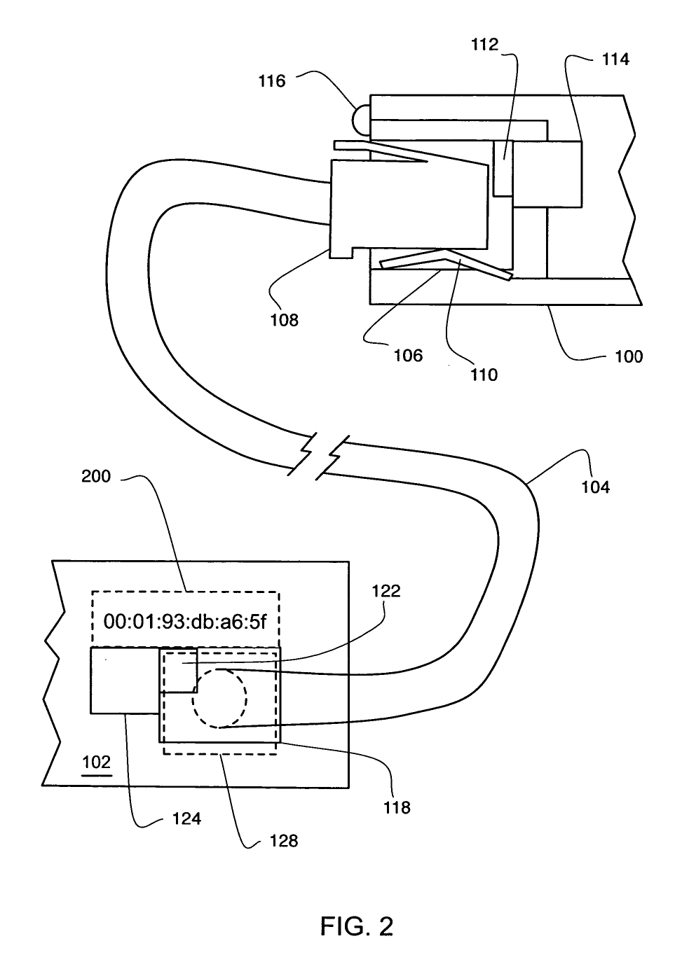

FIG. 2 depicts a variation of the FIG. 1 embodiment in which second device 102 includes a display 200 connected with logic circuit 124 and capable of displaying information to a user in place of indicator 126. As depicted in the FIG. 2 embodiment, display 200 displays an Ethernet MAC address, e.g., the address of second device 102, to a user responsive to receipt of a trace signal from first device 100. In other embodiments, display 200 displays the address of first device 100 if the address is received in the trace signal. In still other embodiments, display 200 can display other information to a user, e.g., an IP address of first device 100 or second device 102, etc. Similar to the illumination of indicator 126 described in conjunction with the FIG. 1 embodiment, the information displayed by indicator 200 may be displayed for a predetermined time period, in a predetermined pattern, subject to receipt of an additional signal from first device 100, combinations thereof, etc.

In another embodiment, second device 102 includes both indicator 126 and display 200 connected with logic circuit 124.

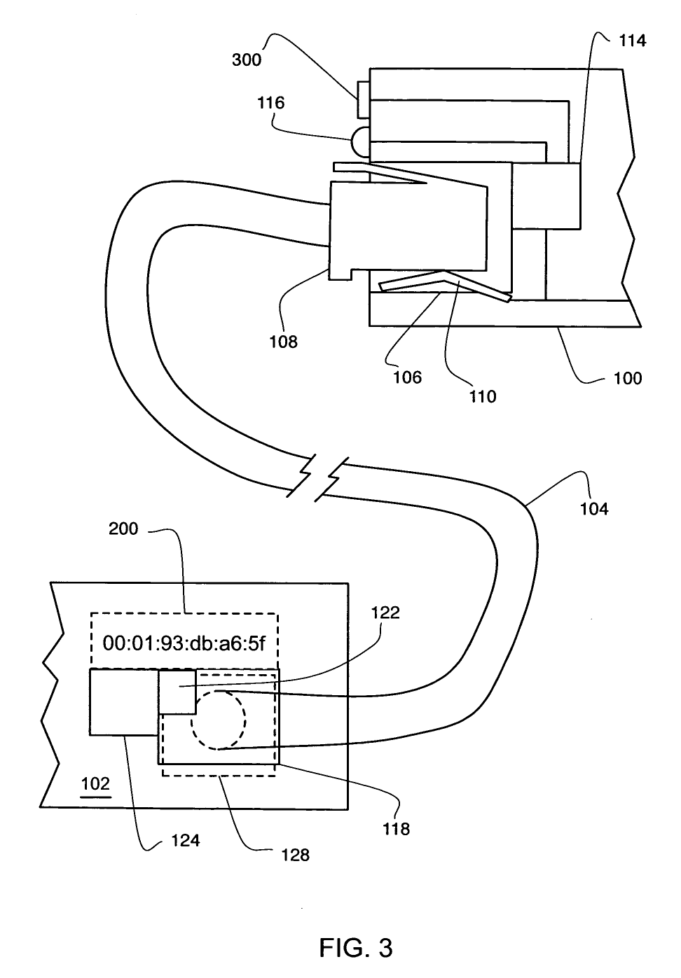

FIG. 3 depicts a variation of the FIG. 2 embodiment in which first device 100 includes an externally-actuatable switch 300 in place of actuator switch 112 in receiver 118. Switch 300 is connected with logic circuit 114 and operates based on user manipulation of the switch instead of based on plug 108 activation to generate and transmit the switch activation signal to the logic circuit.

In another embodiment, logic circuit 114 response to a switch activation signal generated as part of the operation of first device 100, e.g., execution of the operating system of the first device. In this manner, a user is able to manipulate first device 100 via another input mechanism, e.g., the users interface displayed to the user, and cause the generation of the switch activation signal to logic circuit 114.

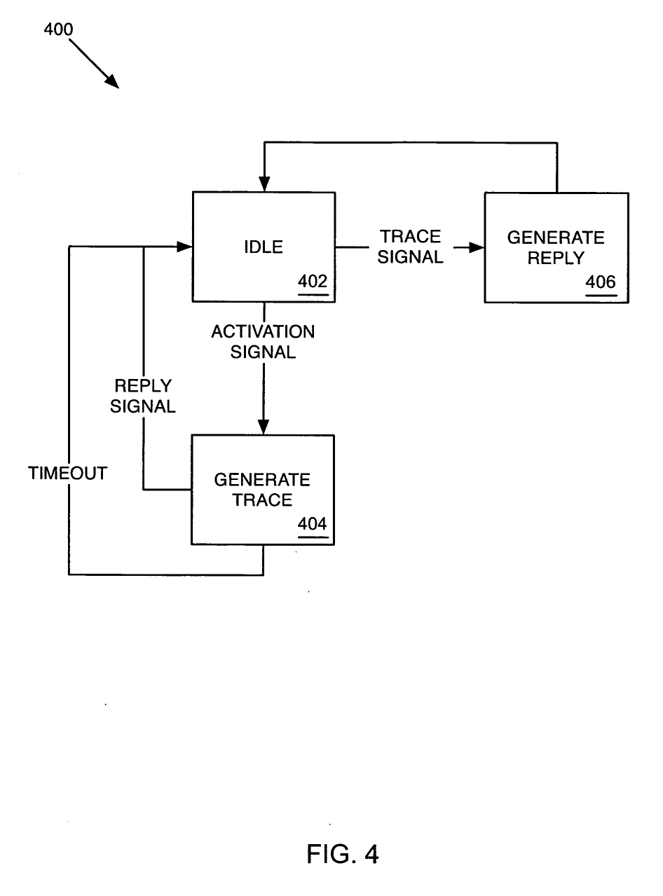

FIG. 4 depicts a high level block diagram of a process flow 400 of logic circuit 114 according to an embodiment. Responsive to receipt of the above-described switch activation signal at idle step 402, logic circuit 114 proceeds to step 404 and generates and transmits the above-described trace signal, e.g., as described above with respect to the trace signal generated by first device 100. At step 404, logic circuit 114 waits for either receipt of a reply signal responsive to the trace signal or a predetermined time period within which no reply signal has been received. The flow proceeds to return to idle step 402 upon receipt of a reply signal or expiration of the predetermined time period.

In an embodiment, logic circuit 114 causes indicator 116 to illuminate upon receipt of either or both of the activation signal and the reply signal, i.e., the indicator illumination may be used to indicate the beginning of a trace or the completion of a trace. In other embodiments, indicator 116 may be illuminated in a pattern to indicate that logic circuit 114 is awaiting a reply signal. In still other embodiments, indicator 116 may be illuminated to indicate additional status information.

Returning now to step 402, responsive to receipt of a trace signal the flow proceeds to step 406 and logic circuit 114 generates and transmits a reply signal, e.g., as described above with respect to the reply signal generated by second device 102. After generating and transmitting the reply signal, the flow proceeds to return to step 402. In an embodiment, first device 100 causes indicator 116 to illuminate after receipt of the trace signal.

In another embodiment, logic circuit 114 waits for receipt of another signal, e.g., a second trace signal, prior to transitioning to step 402. In this manner, the illumination of indicator 116 may be controlled by the trace signal originating device. In still another embodiment, logic circuit 114 waits for expiration of a predetermined time period prior to transitioning to step 402.

As described above, logic circuit 114, in differing embodiments, may cause illumination of indicator 116 in accordance with predetermined patterns or responsive to trace status information, etc.

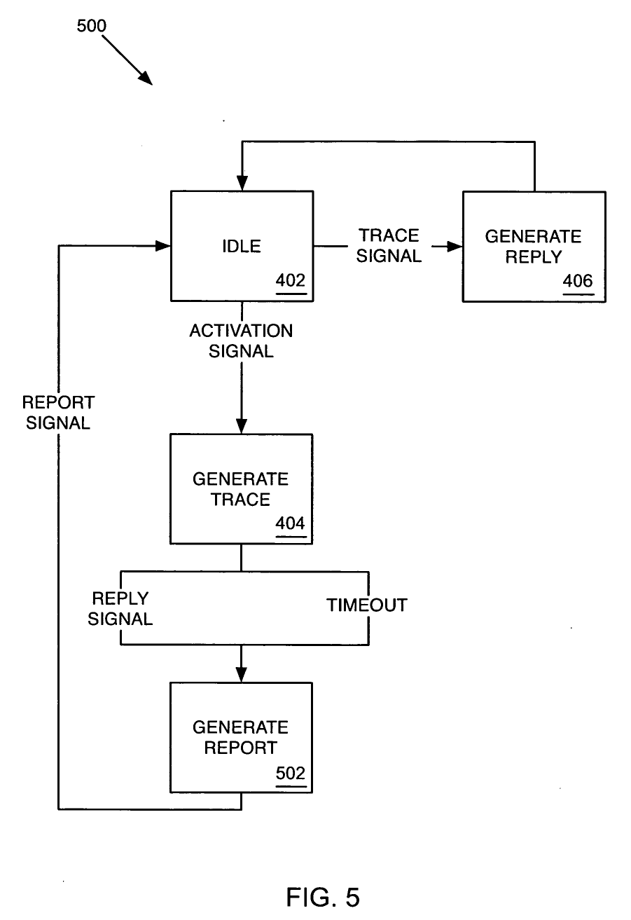

FIG. 5 depicts a process flow 500 which is a variation on process flow 400 of the FIG. 4 embodiment of logic circuit 114. Idle step 402 and generate trace step 404 occur as described above with respect to FIG. 4. Process flow 500 differs from flow 400 in that the process flow proceeds from step 404 to a step 502 in response to either receipt of a reply signal or expiration of a predetermined time period. At step 502, logic circuit 114 generates and transmits a reporting signal to a user, e.g., by causing a display to display information based on trace signal, reply signal, first device information, second device information, time period expiration, or a combination thereof, etc. In an embodiment in which first device 100 includes a display such as display 200 (FIG. 2), logic circuit 114 causes display of relevant trace information via the display at first device 100. Trace information includes information and data related to a trace signal generated by logic circuit 114, e.g., time of trace initiation, duration of trace, origination address of trace, destination address(es) of trace, time of reply, etc.

In another embodiment, logic circuit 114 generates and transmits the reporting signal to another device connected with first device 100, e.g., a connected computer system. In still another embodiment, logic circuit 114 generates and stores the reporting signal in a storage location, e.g., memory (not shown), of first device 100.

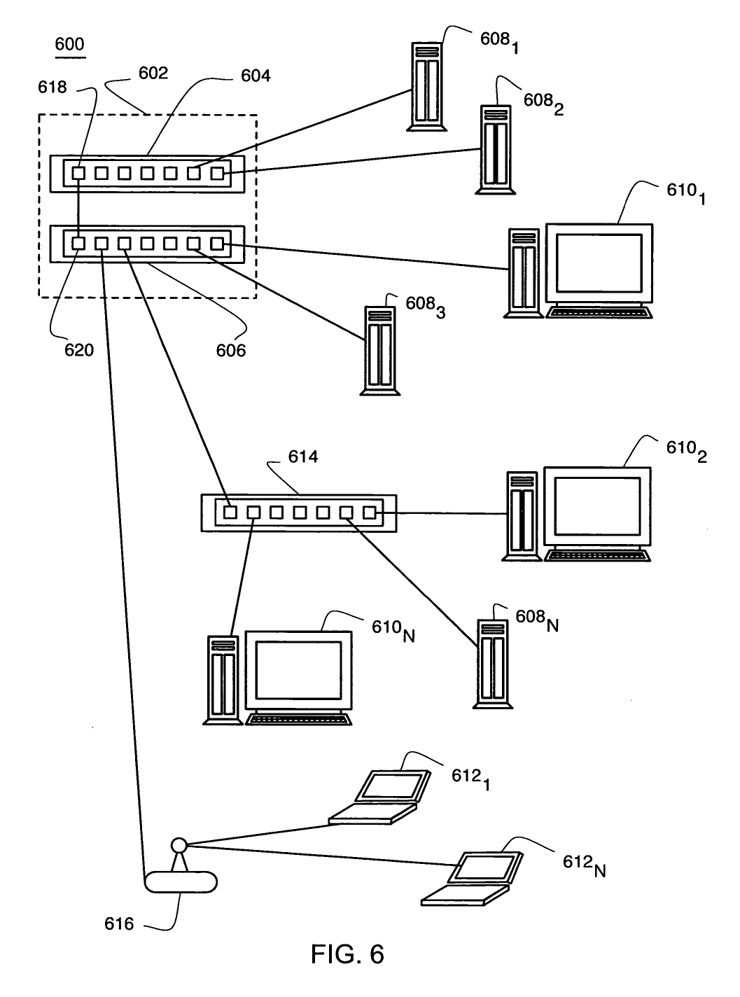

FIG. 6 depicts a high level block diagram of a network 600 in which an embodiment is installed. Network 600 includes a switching center 602 (dashed lines), e.g., one or more rack-mounted switching devices, including first and second network switches 604, 606. Network 600 further includes networked devices, i.e., servers 608₁-608_{N}, desktop computers 610₁-610_{N}, laptop computers 612₁-612_{N}, a third network switch 614, and a wireless access point 616. Switching center 602 interconnects servers 608₁-608_{N}, desktop computers 610₁-610_{N}, laptop computers 612₁-612_{N}, third network switch 614, and wireless access point 616. Servers 608₁-608₃, desktop computer 610₁, third network switch 614, and WAP 616 are directly connected to switching center 602. Specifically, servers 608₁, and 608₂ are directly connected with first network switch 604 and server 608₃, desktop computer 610₁, third network switch 614, and WAP 616 are directly connected with second network switch 606. Third network switch 614 interconnects desktop computer 610₂, 610_{N} and server 608_{N} with switching center 602, and more specifically with first network switch 604. WAP 616 interconnects laptop computers 612₁, 612_{N} with switching center 602, and more specifically with second network device 606. Each device connected with a network switch 604, 606, 614 is connected at a different port of the switch.

As described above, in operation one or more of the FIG. 6 devices includes a logic circuit 114. For example, a user activating actuator switch (not shown) on a first port 618 of first network switch 604 causes a logic circuit (not shown) of the first network switch to generate and transmit a trace signal over the cable connecting the first port of the first network switch to a first port 620 of the second network switch 606. A logic circuit (not shown) at first port 620 generates and transmits a reply signal over the cable connecting the first port of the second network switch back to first port 618. As described above, indicators (not shown) may be illuminated at each or both of first and second network switches 604, 606.

After receipt of the reply signal from second network switch 606, first network switch 604 transmits a reporting signal to server 6081. In other embodiments, reporting signal may be transmitted and/or stored at first network switch 604, or another connected device in network 600. In still other embodiments, reporting signal may be displayed at first network switch 604 via a display (not shown), as described in conjunction with FIG. 2 above.

Laptop computers 612₁, 612_{N} include a logic circuit including functionality similar to logic circuit 114 described above. In particular, based on software activation laptop computer 612₁ transmits a trace signal to WAP 616 and WAP 616 including a logic circuit (not shown) responds with a reply signal, as described above. In this manner, a wired or wireless connection mechanism can be used in embodiments.

Similar operations can be performed between any two devices in network 600 in order to determine connections between the two devices.

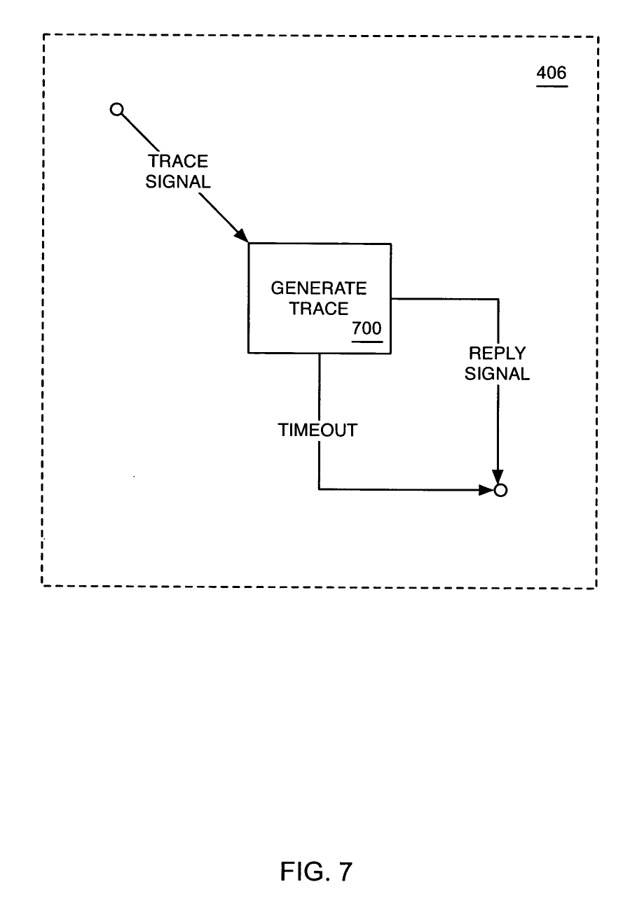

FIG. 7 depicts a functional process flow diagram of a variation on the embodiment of step 406 (FIG. 4). After logic circuit 114 receives a trace signal and transitions from step 402 to step 406, as depicted and described above, the logic circuit proceeds to step 700. At step 700, if the device including logic circuit 114 has more than one network connection, e.g., network switch 604, 606, 614, WAP 616, the logic circuit generates and transmits one or more additional trace signals using one or more of the network connections. In an embodiment, step 700 causes the generation and transmission of an additional trace signal for each additional connection of the device. An additional trace signal is not transmitted via the connection which received the originating trace signal.

As described in conjunction with step 406 (FIG. 4), logic circuit 114 waits for either receipt of a reply signal responsive to each of the additional trace signals transmitted or expiration of a predetermined time period. After receipt of the reply signal or expiration of the time period, the flow proceeds as described in conjunction with FIG. 4, i.e., the flow proceeds to return to step 402 and logic circuit 114 generates and transmits a reply signal via the originating trace connection. In this manner, a recursive topology trace of a network of connected devices is executed using a distributed interface.

Returning to FIG. 6, activation of generation and transmission of a trace signal from first network device 604 to server 608₁ results in a determination and identification of the connection between the two devices. Transmission of the trace signal from first port 618 of first network device 604 is received by first port 620 of second network switch 606 and causes the second network switch to generate and transmit a trace signal to all connected devices. In turn, third network switch 614 generates and transmits a trace signal to all connected devices responsive to receipt of the additional trace signal from second network switch 606. Similarly, WAP 616 generates and transmits a trace signal to all connected devices responsive to receipt of the additional trace signal from second network switch 606.

After each connected device transmits a reply signal to the originating device or the predetermined time period for receiving responses expires, the entire connected network of devices has been traced. In this manner, activation of a trace from a first device causes a recursive determination of the network topology. Additionally, if each device includes an indicator 126, each of the connected device indicators are illuminated to indicate their connectivity.

In another embodiment, each device receiving a reply signal includes the information received from the reply-generating device. In this manner, the network topology information acquisition and collection are activated at a single location. In different embodiments, the single location may be one or another of devices including the above-described embodiment. The above embodiments describe a distributed interface for determining connectivity topology among connected devices. Connectivity, as well as, statistical and performance information can be collected in this manner, as well.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A network port for tracing a connection topology, comprising:
a logic circuit connected with a communication path for connecting with another network port, the logic circuit arranged to generate and cause transmission of a trace signal over the communication path responsive to receipt of an activation signal, the logic circuit arranged to cause generation of an indicator indicative of at least one of: receipt of a reply signal over the communication path responsive to transmission of the trace signal and expiration of a predetermined time period.

2. A network port as in claim 1, comprising:
an actuator operatively connected with the logic circuit and arranged to generate a activation signal responsive to activation by a network plug at a first end of the communication path connected with the network port.

3. A network port as in claim 2, comprising:
a signal generator operatively connected with the logic circuit and arranged to generate an indicator responsive to receipt of an indicator signal from the logic circuit; and
wherein the logic circuit is arranged to drive an indicator signal to the signal generator in response to receipt of at least one of: the reply signal from the network plug and the activation signal.

4. A network port as in claim 3, wherein the indicator generated by the signal generator is at least one of a visual signal and an audio signal.

5. A network port as in claim 2, wherein the actuator is arranged to be activated by insertion of the network plug farther in the network port than required for establishing a signal connection between the network cable and the network port.

6. A network port as in claim 1, wherein the trace signal is transmitted over the received network cable.

7. A network port as in claim 1, wherein the trace signal generated by the logic circuit comprises: a predetermined format packet.

8. A device as in claim 7, wherein the trace signal generated by the logic circuit is a predetermined format packet comprising at least one of:
a port identifier of the network port in a network device;
a device identifier of the network device; and
a MAC address of the network device.

9. A network port as in claim 1, comprising:
an actuator operatively connected with the logic circuit and arranged to generate an activation signal responsive to activation by a user.

10. A network port as in claim 1, wherein the logic circuit is further arranged to generate a reply signal for transmission over the communication path in response to receipt of a trace signal from the communication path.

11. A network port as in claim 10, wherein the logic circuit is further arranged to generate an other trace signal for transmission over an other communication path connected with the logic circuit responsive to receipt of the trace signal and the logic circuit is arranged to generate a reply signal responsive to at least one of: receipt of an other reply signal over the other communication path responsive to transmission of the other trace signal and expiration of a predetermined time period.

12. A network device, comprising:
a network adapter arranged to establish a connection between the network device and another network device via a network cable, the network adapter comprising:
a network port as in claim 1.

13. A network port for tracing a connection topology, comprising:
a logic circuit arranged to be operatively connected with a network cable via a network plug received in the network port and arranged to generate a reply signal in response to receipt of a trace signal from the network plug, wherein the reply signal is a predetermined format packet; wherein the logic circuit is arranged to generate an indicator signal responsive to: receipt of the trace signal and generation of the reply signal, and
a signal generator operatively connected with the logic circuit and arranged to generate an indicator responsive to an indicator signal from the logic circuit.

14. A network port as in claim 13, wherein the logic circuit is further arranged to generate an other trace signal for transmission over an other communication path connected with the logic circuit responsive to receipt of the trace signal and the logic circuit is arranged to generate a reply signal responsive to at least one of: receipt of an other reply signal over the other communication path responsive to transmission of the other trace signal and expiration of a predetermined time period.

15. A network port as in claim 13 wherein the predetermined format packet comprises at least one of:
a port identifier of the sender of the packet;
a device identifier of the sender of the packet; and
a MAC address of the sender of the packet.

16. A method for tracing a connection topology between at least two connected devices, comprising:
transmitting a trace signal from a first device to a second device responsive to receipt of an activation signal;
generating an indicator indicative of at least one of: receipt of a reply signal from the second device responsive to transmission of the trace signal and expiration of a predetermined time period.

17. The method as in claim 16, further comprising:
generating an activation signal responsive to insertion of a network plug in the first device.

18. The method as in claim 16, further comprising:
generating an other trace signal from the second device to an other device connected with the second device responsive to receipt of the trace signal at the second device;
generating a reply signal at the second device for transmission to the first device responsive to at least one of: receipt of an other reply signal from the other device responsive to transmission of the other trace signal and expiration of a predetermined time period.

19. The method as in claim 18, wherein the reply signal comprises the other reply signal from the other device.

20. The method as in claim 16, wherein either or both of the trace signal and the reply signal are a predetermined format packet comprising at least one of:
a port identifier of the sender of the packet;
a device identifier of the sender of the packet; and
a MAC address of the sender of the packet.
